(19) United States
(12) Patent Application Publication
(10) Pub. No.: US 2021/0190504 A1
(43) Pub. Date: Jun. 24, 2021

(54) SYSTEMS AND METHODS FOR NAVIGATION

(71) Applicant: ARM IP Limited, Cambridge (GB)

(72) Inventors: Bijal Bharat Hayes-Thakore, Fulbourn (GB); Brendan James Moran, Histon (GB)

(73) Assignee: ARM IP Limited, Cambridge (GB)

(21) Appl. No.: 16/638,681

(22) PCT Filed: Aug. 14, 2018
(86) PCT No.: PCT/GB2018/052314

§ 371 Date: Feb. 12, 2020

(30) Foreign Application Priority Data
Aug. 25, 2017 (GB) 1713675.5

(51) Int. Cl. G01C 21/20; G01C 21/34; G01C 21/00; H04W 4/024; H04W 4/33

(52) U.S. Cl. CPC G01C 21/206; G01C 21/3484; H04W 4/33; H04W 4/024; G01C 21/005

(57) ABSTRACT

A method of generating route instructions for a user, the method comprising: receiving, at a control system, device attribute data for a plurality of node devices in a facility; storing, in a data set, the device attribute data, wherein the data set further comprises operation data relating to the operating state of respective node devices; receiving, at the control system, user attribute data for a user; generating, at the control system, route instructions specifying a source location, a destination location and one or more waypoints therebetween based on or in response to the data set and the user attribute data; transmitting, from the control system to the user, the route instructions.

### RELATED APPLICATIONS

The present application is a National Phase entry of PCT Application No. PCT/GB2016/052314, filed Aug. 14, 2018, which claims priority from GB Patent Application No. 17 13675.5, filed Aug. 25, 2017, said applications being hereby incorporated by reference herein in their entirety.

The present techniques relate to systems and methods for deriving attributes about devices and objects distributed around a facility and generating instructions to allow a user to navigate thereto.

There is an ever-increasing number of devices providing smart functionality/capabilities as part of the Internet of Things (IoT). For example, a heating system in an office block may gather information from various temperature sensor devices and control activation of the heaters based on the gathered information. In another example, a pollution monitoring system in a chemical factory may gather information from various sensors around the factory and arrange maintenance via the Internet based on the gathered information. In another example, a lighting system may gather information from lights and motion sensors within a subterranean tunnel system and control one or more lights in response to detected motion.

It can be onerous to locate devices in buildings using traditional technologies such as paper maps, due to such paper maps being required to be populated as new devices are added/updated which can be time consuming.

Furthermore, satellite systems such as GPS are generally not suitable for indoor use.

The present techniques seek to provide improvements to traditional technologies for locating devices.

According to a first technique there is provided a method of generating route instructions for a user, the method comprising: receiving, at a control system, device attribute data for a plurality of node devices in a facility; storing, in a data set, the device attribute data, wherein the data set further comprises operation data relating to the operating state of respective node devices; receiving, at the control system, user attribute data for a user; generating, at the control system, route instructions specifying a source location, a destination location and one or more waypoints therebetween based on or in response to the data set and the user attribute data; transmitting, from the control system to the user, the route instructions.

According to a further technique there is provided a method of generating route instructions in a facility, the method comprising: harvesting, at a first data processing unit, device attribute data from one or more node devices in the facility; transmitting, from the first data processing unit to a control system, the device attribute data; generating, at the control system, route instructions for a user, the route instructions specifying a source location, a destination location and one or more waypoints therebetween based on or in response to the device attribute data and the user attribute data; transmitting, from the control system to a second data processing device, the route instructions.

According to a further technique there is provided a method of identifying routes in a facility, the method comprising: receiving, at a control system, device data for a plurality of node devices in the facility; generating, at the control system in response to the received device data, a directed annotated graph comprising vertices representative of respective node devices of the plurality of node devices and further comprising edges, each edge representative of a route between respective devices; analyzing the received data to determine the presence of one or more objects and providing vertices representative of the one or more objects on the directed annotated graph and further providing one or more edges, each edge representative of a route between respective objects and/or node devices; identifying, from the directed annotated graph, a route between source and destination vertices based on or in response to user attribute data.

According to a further technique there is provided a navigation system comprising: a control system; a plurality of node devices; a data processing unit to harvest device attribute data from the plurality of node devices and to transmit the harvested device attribute data to the control system; wherein, the control system determines the positions of the plurality of node devices and one or more objects from the harvested device attribute data and identifies one or more routes comprising waypoints therebetween.

According to a further technique there is provided a method of generating route instructions in a facility for a user, the method comprising: generating, at a control system, route instructions specifying a source location, a destination location and one or more waypoints therebetween based on or in response to one or more of: user type data of the user, user capabilities data of the user, user authentication data of the user and user positional data of the user; transmitting, from the control system to the user, the route instructions.

The present techniques are diagrammatically illustrated, by way of example, in the accompanying drawings, in which:

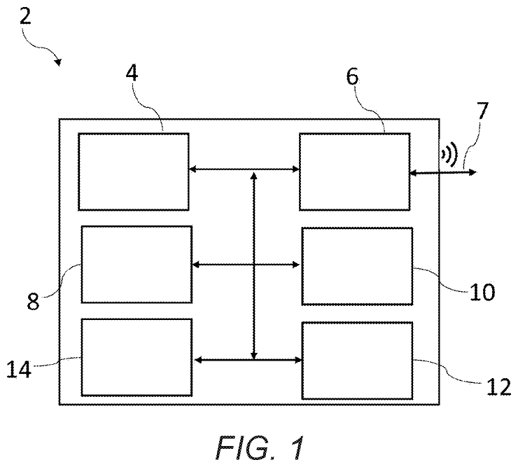

FIG. 1 is an illustrative example of a block diagram of a node device according to an embodiment;

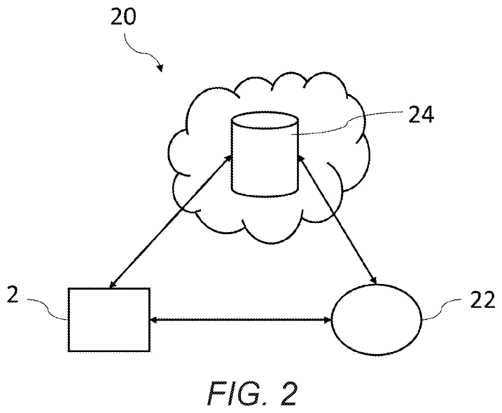

FIG. 2 is an illustrative example of a navigation system comprising a node device, a user device unit, and a control system;

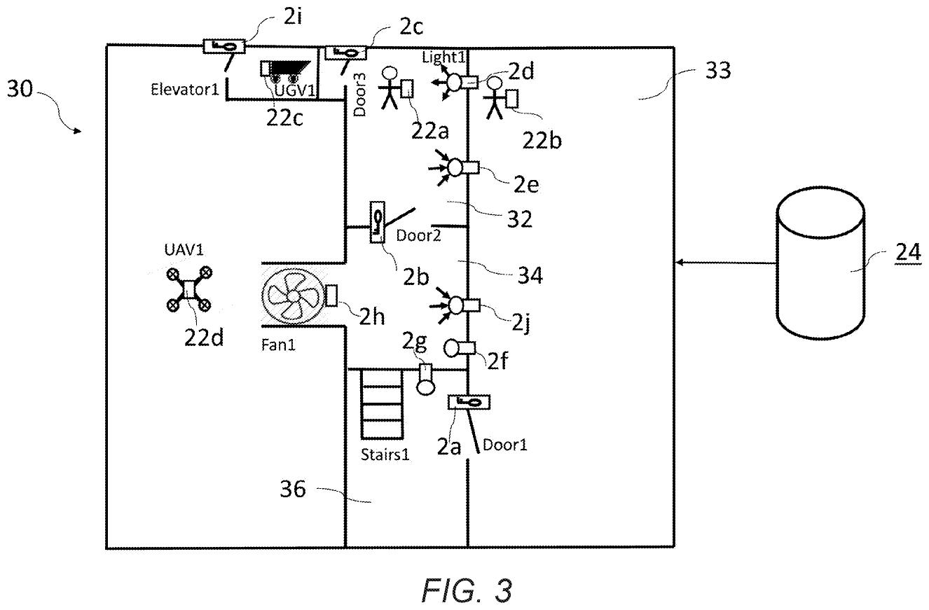

FIG. 3 is an illustrative example of a facility having the navigation system of FIG. 2 according to an embodiment;

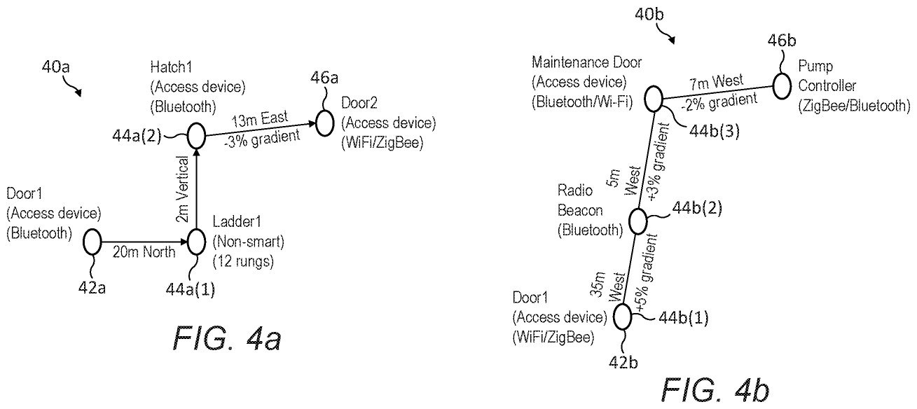

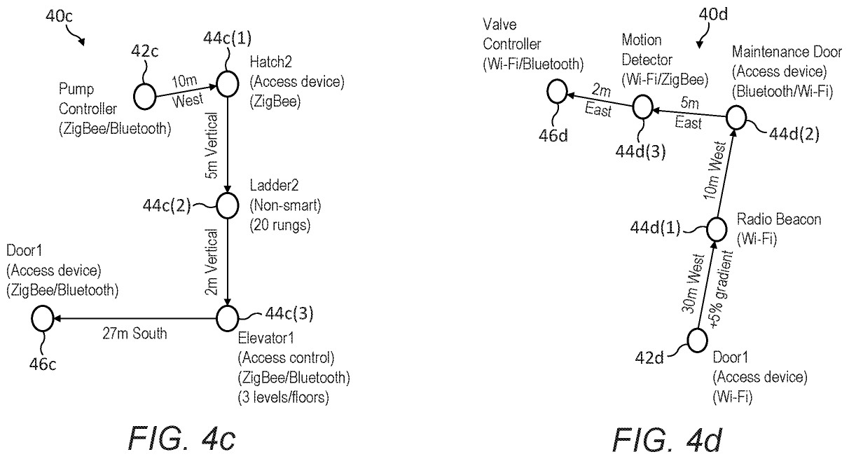

FIGS. 4a-4d are illustrative examples of graphs generated from a source location to a destination location;

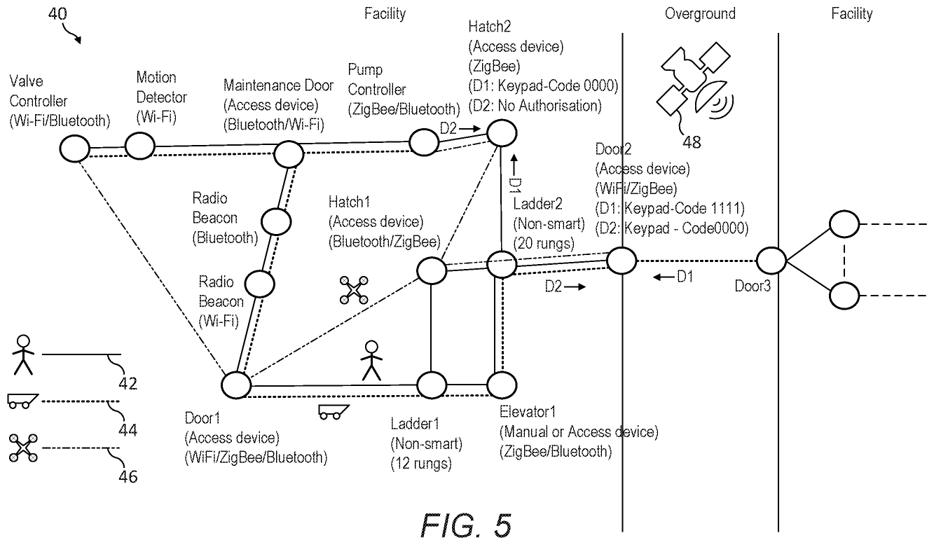

FIG. 5 is an illustrative example of an aggregated graph of the different routes;

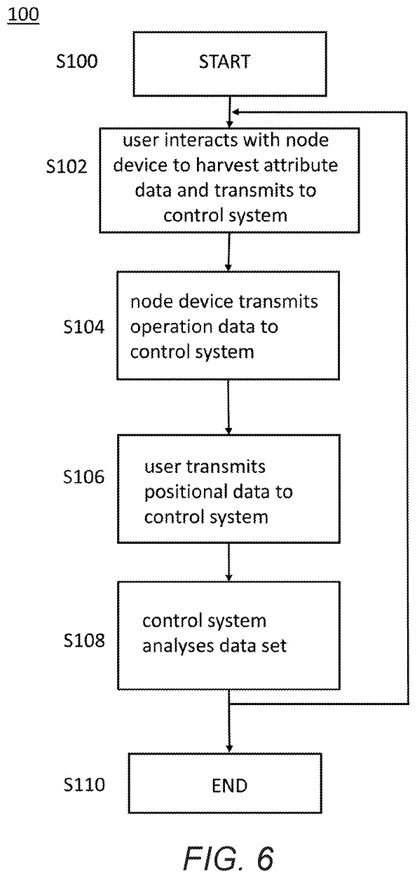

FIG. 6 is a simplified flow diagram illustrating a method of collecting, at a control system, data from node devices or a user; and

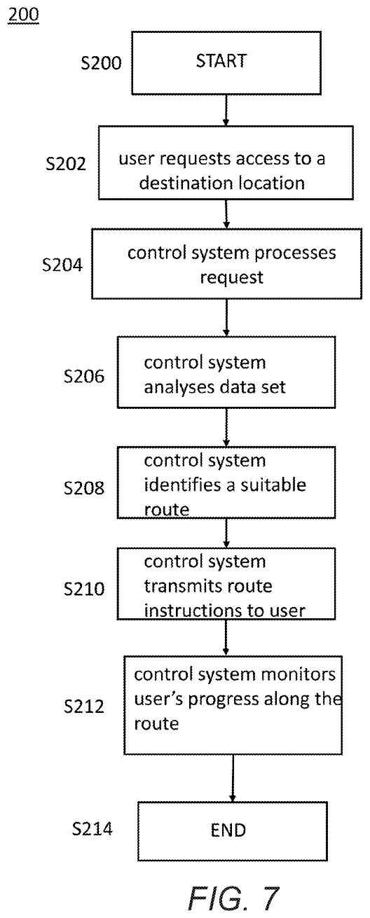

FIG. 7 is a simplified flow diagram illustrating a method of generating, at a control system, route instructions from a source location to a destination location in a facility.

The present techniques provide a way of directing a user to a location in a facility.

The term “user,” as used herein is interpreted broadly and can refer to a human user or an automated user, such as an unmanned ground vehicle (UGV), such as a cart, or unmanned aerial vehicle (UAV), such as a drone.

The term “facility,” as used herein is also interpreted broadly and can refer to a wide variety of structures including, but not limited to residences, offices, retail stores, museums, farms, manufacturing plants, ocean-going vessels, space-going vessels, space laboratories, water management plants, tunnels (e.g. underground rail tunnels, maintenance ducts, waste (sewer) pipes) as well as surrounding areas.

Furthermore, while techniques may relate to the interior of a facility, the techniques disclosed may also be applied to the exterior of a facility. For example, smart objects may be positioned on a roof of a facility, or within a separate structure (for example an annex). In some embodiments, a facility, or portion thereof, may include an outside space. For example, embodiments may be used in an “open-air” stadium, a garden, or an external walkway.

FIG. 1 schematically shows a block diagram of a node device 2, which may be a device in the Internet of Things (IOT).

The node device 2 may be associated with one or more objects in a facility, and may be used to turn objects into “smart objects”. Such smart objects may include access objects (e.g. doors/windows; shaft covers, access hatches), environmental objects (e.g. lights or heating, ventilation, air conditioning (HVAC) units), although this list of smart objects is not exhaustive.

Node device 2 comprises processing circuitry 4, such as a microprocessor or integrated circuit(s) for processing data and for controlling various operations performed by the node device 2 or associated smart object.

The node device 2 also has communication circuitry 6 for communicating with one or more resources remote therefrom such as a computer terminal or mobile device, service (e.g. cloud service), gateway device (not shown) etc.

The communication circuitry 6 may use wireless communications 7, such as communications used in, for example, wireless local area networks (WLAN) and/or wireless sensor networks (WSN) such as Wi-Fi®, Thread®, ZigBee®, Bluetooth®, Bluetooth Low Energy® (BLE), LoRA®, NB-IoT, etc., using any suitable communications protocol such as lightweight machine-to-machine (LWM2M). The communication circuitry 6 may also comprise short range communication capabilities such as radio frequency identification (RFID) or near field communication (NFC).

The node device 2 also comprises storage circuitry 8 (e.g. non-volatile/volatile storage), for storing data provisioned on or generated by the node device 2, hereafter “device data”.

Such device data includes one or more device identifiers to identify the node device 2, which may comprise one or more of: universally unique identifier(s) (UUID), globally unique identifier(s) (GUID) and IPv6 address(es), although any suitable device identifier(s) may be used.

The device data may also include authentication data for establishing trust/cryptographic communications between the node device 2 and a remote resource. Such authentication data may include certificates (e.g. signed by a root authority), cryptographic keys (e.g. public/private keys; symmetric key pairs), tokens etc. The authentication data may be provisioned on the node device 2 by any authorised party (e.g. by an owner, a manufacturer, or an installer).

The node device 2 may also be provisioned with, or generate, other device data. For example, the node device 2 comprises sensor circuitry 10 having sensors to detect user activity or interactions (e.g. user presence, user movement, user interaction etc.).

The sensor circuitry 10 may additionally, or alternatively, comprise sensors to detect changes in the environment local to the node device such as a light, humidity and/or temperature sensors.

The node device 2 also comprises input/output circuitry 12, whereby the output circuitry 12 may be used to provide instructions for an associated smart object to perform an action (e.g. to turn on/off a light or HVAC unit; to open a door; to activate a lift).

The node device 2 also comprises power circuitry 14 to power the various circuity and components therein. In examples, the power circuitry comprises a battery. Additionally, or alternatively, the power circuitry comprises an energy harvester (e.g. Wi-Fi harvester), which may be used to power the various circuitry and components and/or to charge the battery. In other examples, the power circuitry may be connected to mains power supply.

As above node devices may be associated with smart objects in a facility and it may sometimes be necessary for a user to access the node devices or smart objects in order to perform maintenance thereon (e.g. to change an associated lightbulb, or perform servicing or repairs). However, the node devices or smart objects maybe difficult to locate due to being in a remote location of the facility.

A user has an associated data processing device or unit (hereafter “positional interaction unit” (PIU)), whereby the PIU interacts with the node devices to harvest one or more attributes of the node device (hereafter “device attribute data”), and transmit the device attribute data to a remote resource, hereafter “control system”.

In other examples, a node device will transmit data relating to its current operating state to the control system (hereafter “operation data”). For example, the operation data may indicate that an associated light is turned on or off, an associated fan is turned on or off, user motion was detected, a user requested access to open a door etc. The operation data is transmitted from the respective node devices to the control system at some interval (e.g. every hour, day etc), or based on some triggering event such as, for example: a physical event (e.g. detecting motion of a user or opening of a door), an acoustic event (e.g. detecting a user's voice or footsteps); an optical event (e.g. detecting a light turning on or off); a radio event (e.g. detecting signals from a user's PIU).

FIG. 2 shows an illustrative example of a navigation system 20 comprising a node device 2, PIU 22, and control system 24.

Although only one node device is depicted in facility navigation system 20, any number of node devices 2 may be provided in one or more networks and in any suitable topology such as peer-to-peer, mesh, distributed, and/or centralized topologies.

The PIU 22 may comprise any suitable data processing device (such as a mobile telephone or tablet device) to provide directions to the user, e.g. via a graphical user interface (GUI). In other examples, the PIU 22 may comprise a module on an automated/computerised user, to receive and process command data received from the control system 24.

The PIU 22 comprises communication circuitry to communicate with the node device 2 and control system 24, and may use wireless communications similar to those described above in relation to the node devices, such as communications used in, for example, wireless local area networks (WLAN) and/or wireless sensor networks (WSN) such as Wi-Fi, ZigBee, Bluetooth or Bluetooth Low Energy (BLE), radio frequency identification (RFID) or near field communication (NFC), cellular (e.g. 3G, 4G), LoRA, NB-IoT etc., using any suitable communications protocol.

The PIU 22 also comprises location determination circuitry, which may, for example, comprise a global positioning system (GPS) unit.

The location determination circuitry may, additionally, or alternatively, comprise an inertial motion reference unit to provide its position over time.

The PIU 22 may also engage in positioning operations with one or more node devices 2 with which it interacts, to determine its position relative to the nodes devices 2 or to determine the positions of the node devices.

Such positioning exchanges may include RSSI (received signal strength indicator), time of flight (TOF) and/or round-trip time (RTT) operations using, for example, beacon detectors for Bluetooth, Wi-Fi, 802.15.4, ultrasound, millimetre wave RADAR and/or LiDAR. In other examples fingerprinting electromagnetic (EM) noise or acoustic noise may be used to determine the position of the PIU or one or more node devices with which it interacts.

Additionally, or alternatively, the PIU may broadcast a signal such that the one or more node devices can engage in positioning operations with the PIU to determine the position of the PIU and update the control system accordingly.

The PIU 22 may also transmit data relating to attributes of the user or PIU (hereafter “user attribute data”) to the control system, whereby the user attribute data relates to one or more attributes of the user and/or the PIU itself such as: user type (e.g. human/UAV/UGV); mobility capabilities (e.g. wheeled vehicle—avoid steps; human—avoid hazardous areas); (e.g. object identification capabilities); device identifiers (e.g. GUID; UUID etc.); communication capabilities (e.g. ZigBee®, Wi-Fi®; Bluetooth® etc.); location attributes (e.g. providing the physical location of the PIU (e.g. as determined using GPS, inertial motion reference, RSSI, TOF, RTT or any suitable method)). It will be appreciated that the physical location may include horizontal and/or vertical position (elevation/height) of the node device which may be determined, for example, using a barometer on the PIU 22 or any suitable techniques.

Although only one PIU 22 is depicted in system 20, any number of PIUs may be provided.

Control system 24 communicates with different devices in the facility (e.g. node devices, PIUs etc.) to receive and process data from the different devices and may comprise, for example, a computer, server, or cloud service, although this list is not exhaustive.

The control system 24, node device 2 and/or PIU 22 may be located on the same or different networks. For example, in FIG. 2, the data processing device 24 is depicted as being located on the cloud (e.g. the internet), whereby the node devices and/or PIUs may communicate therewith via edge routers. However, the claims are not limited in this respect and the control system 24 may be provided on the same or different networks as the node devices/PIUs.

The control system 24 may transmit data to the different node devices in the facility to perform an action (hereafter “command data”), such as, for example, instructing the node devices to: turn on/off an associated environmental object, lock/unlock or open/close an associated access object.

Additionally, or alternatively, control system 24 also generates instruction data comprising a route (hereafter “route instructions”) for a user to reach a particular location or device in the facility, whereby the route instructions are presented as human readable instructions for a human user (e.g. as a visual map or graph and/or as text instructions), or as command data for an automated/computerised user.

The control system 24 also comprises a data store to store the data received from the node devices and/or PIUs 22. In embodiments, the data store may be provided as part of the control system or may be on a different network in communication therewith.

In embodiments, the control system 24 performs data analysis on data received from the node devices or PIUs, and to generate the route instructions in response to the data analysis. Any suitable data analysis may be used, such as statistical models, Bayesian approaches, neural networks, or machine learning.

As an example, the control system 24 may generate routes for a particular type of user, whereby, on determining that the user is a human (e.g. based on the PIU's user attribute data (e.g. type data), the control system 24 may provide a route to a particular location which may encompass ladders, catwalks, stairs etc. In another example, on determining that the user is a UGV or a human with a cart, the control system 24 may provide a different route to the particular location, which may encompass pathways accessible by a wheeled vehicle, remotely controlled access doors and elevators.

Alternatively, on determining that the user is a UAV, the control system 24 may provide an even further different route to the particular location, which may encompass air ducts and electrical ducts, which may be inaccessible for the human or UGV but through which the UAV can navigate.

The control system can monitor the user's position along the route by monitoring the positional data from the PIU or node devices (received as the user traverses the route) or monitoring the operation data (e.g. transmitted from the node devices in response to user interactions therewith as the user traverses the route).

The control system 24 can then control node devices/associated smart objects to perform an action to guide the user as the user traverses the route. For example, the control system can call an elevator as the user approaches the entrance thereto, or can unlock or open a door as the user approaches a room.

The control system can also actively guide the user as the user traverses the route. As an illustrative example of such active guidance, the control system 24 may transmit command data to node devices along the route to emit light of a first color and/or shape (e.g. green arrow in the direction the user should travel), and to emit light of a different color and/or shape (e.g. a red cross in directions other than the route the user should travel), so the user will know not to return on itself. As a further illustrative example of active guidance, the control system may instruct node devices to emit a particular sound as the user traverses the route in the correct direction, and to emit a different sound when the user deviates from the route defined by the route instructions.

The control system may detect that the user has deviated from the route by, for example, detecting that the user entered a room which was not on the route, or not detecting user motion by motion detector along the route which is expected to trigger based on operation data received from the respective node devices. On determining that the user has deviated from the route, the control system 24 can transmit updated route instructions to the user. In other examples, the control system could warn the user or another party (e.g. a system owner or administrator) of the deviation by controlling a node device or smart object to emit a warning signal (e.g. by flashing a light; sounding an alarm) or communicating with the user's PIU (e.g. by sending command data to display a warning). Additionally, or alternatively, the command data or warning may be transmitted to the user via SMS or push notifications.

Similarly, when the control system determines that a user is taking longer than expected to progress along the specified route, the control system can request a user input (e.g. to confirm that the user is alive/conscious), and to warn another party that the user has deviated from the route (E.g. if no response is received within a threshold time).

The control system can also monitor for actions of a user along a particular route based on operation data received from one or more node devices with which the user interacts (or doesn't interact with), and take an appropriate action in response.

As an illustrative example, when a user is in a hospital, the route instructions may specify that the user should use hand sanitizer when the user enters or exits a particular area along the route. When the control system detects that the user exits a particular area, and the control system does not receive the expected confirmation that the user operated a particular hand sanitizer station, the control system can take appropriate action, which may include: communicating with a user to remind the user of the required action; transmitting updated route instructions to guide the user to the sanitizer station; warning another party that sanitization was not performed; causing the hand sanitizer station to emit a warning signal to alert the user to its location; or preventing access through an access door along the route until the user operates the hand sanitizer.

It will be appreciated that such functionality is applicable to various other facilities and situations where a user is required to perform a specific action such as boot protection procedures, decontamination procedures, radiation checks, signing-in procedures, de-dusting with pressurized air although this list is not exhaustive.

As above, a PIU 22 can interact with a node device to harvest or collect device attribute data relating to one or more device attributes and transmit the harvested data to the control system 24. For example, when commissioning a node device/associated smart object (e.g. on installation, repurposing or relocating a device), an authorised user, using PIU 22, may harvest device attribute data and transmit the device attribute data to the control system 24.

Such device attribute data may relate to one or more device attributes such as: device type (e.g. light/motion sensor/access control; heater; fan); device control capabilities (e.g. can turn on or off an associated light; lock or unlock an associated door; open or close an associated door; turn on or off an associated fan etc.); sensing capabilities (e.g. motion detection; facial recognition etc.); device identifiers (e.g. GUID; UUID etc.); communication capabilities (e.g. ZigBee®, Wi-Fi®; Bluetooth® etc.). The attributes may also comprise location attributes, providing the physical location, or to allow the control system to determine the physical location, of the node device/associated smart object (e.g. as determined using GPS, RSSI, TOF, RTT or any suitable method).

It will be understood that not all node devices will have the same attributes, and the device attributes listed above are not exhaustive.

In addition to receiving device attribute data from PIU's, the control system 24 may receive device attribute data directly from the node devices 2, which will transmit device attribute data directly to the control system 24.

As above, the node devices 2 may also transmit operation data to the control system 24 in response to a triggering event.

The control system 24 aggregates the device attribute data and/or the operation data to generate a data set from which route instructions can be generated, whereby the route instructions comprise two or more position references (hereafter “waypoints”) such that the user can be routed via the waypoints.

A first waypoint, (hereafter “source location”), final waypoint (hereafter “destination location”) and any waypoints therebetween may comprise one or more of: a node device, its associated smart object, and/or an object without an associated node device (hereafter “non-smart object”).

Such a non-smart object may be a structural feature of the facility such as stairs, ladder, wall, void, maintenance duct etc.

In embodiments, the control system 24 can determine attributes for the non-smart objects by performing data analysis on the data set (e.g. type/position/user action required to traverse a particular non-smart object).

Additionally, or alternatively, a user may inform the control system of the attributes for the non-smart object, whereby a user may manually input, via the PIU, that the door has a particular type of handle (e.g. lever handle, doorknob), or whereby for a non-smart elevator has a push call button, or a set of stairs has, for example, fifteen steps.

The control system 24 can then, based on the determined or received non-smart object attributes and user attribute data, determine whether a particular type of user could traverse a route having the non-smart object. As an example, the control system may determine that a UGV or a user with a cart could not traverse the stairs, while it may determine that a UAV could not operate the door handle. As such, when generating routes, the control system can use the user attribute data to determine whether a particular user could traverse a particular non-smart object.

It will also be appreciated that non-smart objects may be converted to be smart objects by associating a node device therewith to provide device attribute data therefor.

The data set may be enriched over time to increase the accuracy/reliability thereof. As an illustrative example, the location attributes of a newly commissioned node device may be incomplete or inaccurate, whereby the positioning exchanges between a commissioner's PIU and the newly commissioned node device may result in the control system determining a location for the newly commissioned node device to be within ±10 m of the newly commissioned node device's actual location. However, receiving device attribute data from a greater number of users interacting with the node device, will, over time, increase the accuracy/reliability of the device attribute data, such that the control system can more accurately determine the location thereof.

As a further illustrative example, a user's PIU may not be capable of determining certain communication attributes of a node device, whereby the user's PIU may communicate with the node device via Bluetooth and inform the control system that the node device can communicate via Bluetooth. Further users may interact with the node device via Wi-Fi and update the control system that the node device can communicate via Wi-Fi.

As will be appreciated, the route instructions can be refined or optimized based on or in response to the enriched data set whereby refining the routes may comprise increasing the number of waypoints along a particular route overtime (e.g. on identifying new node devices; smart objects or non-smart objects therealong), or identifying the most suitable routes for different users, or determining greater information about a device while optimising the routes may include identifying shorter routes from a source location to a destination location; or identifying routes dependent on a particular user's capabilities (e.g. communication or mobility capabilities).

Furthermore, the accuracy/reliability of the data set may be increased in response to operation data received from node devices, whereby the operation data can be used to support any determinations made by the control system based on, or in response to, the received device attribute data.

With the above in mind, the control system can, using a data set comprising data harvested from node devices, generate route instructions from a source location to a destination location via waypoints therebetween, and can refine the route instructions overtime by enriching the data set. Identifying waypoints along the route means that the user can be provided with instructions from one waypoint to the next waypoint, until the user reaches the destination location. Furthermore, the progression of the user can be monitored as the user traverses along the route so as to take appropriate action if the user deviates from the route.

In examples, the route instructions may be transmitted from the control system 24 to the PIU 22 using any one-way or multi-way communications: e.g. as a broadcast communication, a unicast communication, a multicast communication or as part of a communication exchange between the PIU 22 and the control system 24.

FIG. 3 illustratively shows an example of a facility 30 having facility navigation system comprising control system 24, which receives data (e.g. device attribute data, user attribute data and/or operation data) from node devices 2a-2j and PIUs 22a-22d.

In the present illustrative example, the node devices (or an associated smart object) comprise a first door access control 2a for Door1; a second door access control 2b for Door2; and a third door access control 2c for Door3; a light 2d (Light1); a first light sensor 2e; a first motion sensor 2f; a second motion sensor 2g; an air-conditioning control 2h for Fan1; elevator access control 2i for Elevator1; and a second light sensor 2j.

As described above, data may be harvested from the respective node devices 2a-2j and aggregated into a data set at control system 24. The control system 24 can then generate route instructions from the data set, whereby the data set may be enriched over time as more node devices are installed and/or as more users interact with the node devices. It will be appreciated that the accuracy or reliability of the data set will increase as it is enriched.

Taking FIG. 3 as an illustrative example of such functionality, a commissioning user may, using PIU 22a, commission the light 2d located in a first room 32, and transmit device attribute data for the light 2d to the control system 24, whereby the device attribute data may include the measured signal strength or other positional data. The control system 24 may, using the received data from the commissioning user, incorrectly interpret the location of the light 2d as being located in a second room 33, such that when a second user (with PIU 22b) requests access to the light 2d, the control system 24 provides route instructions to the incorrect location in the second room 33.

In such a scenario, the user may, after following the incorrect route instructions, manually indicate that the light 2d is not located in the second room 33. Although the user may not be able to access the light 2d, the PIU 22b may harvest device attribute data from the light 2d and transmit the harvested data to the control system 24. The control system 24 could then, using the enriched data set with the updated device attribute data, determine that the light 2d is located in the first room 32, and provide updated route instructions to PIU 22b.

Additionally, or alternatively, the control system 24 can use correlations between operation data received from two or more node devices to enrich the data set and improve the accuracy or reliability thereof.

As an illustrative example of such functionality, the control system 24 could use operation data from first light sensor 2e to determine that light 2d is located in the same room as the first light sensor 2e (e.g. in response to the first light sensor 2e detecting signature light flickers from light 2d during a test or commissioning operation).

As a further illustrative example of such functionality, the light 2d may periodically transmit operation data informing the control system that the light is on, and has been emitting light for e.g. 10 minutes, while first light sensor 2e may also periodically transmit operation data informing the control system that the light is detected for 10 minutes. The access control device 2b may transmit operation data informing the control system that Door2 was opened by a user twenty seconds ago; while the second light sensor 2j may transmit operation data informing the control system that light was first detected 20 seconds ago. Therefore, the control system 24 can, in response to correlations between the operation data received from the various devices, determine that the light 2d and first light sensor 2e are located in different rooms to the second light sensor and are separated therefrom by the Door2. The control system 24 can then use this determination to increase the accuracy/reliability of the data set.

As above, the control system 24 can generate routes dependent on the user's attribute data, whereby before generating route instructions, the control system 24 may first check that a user has the necessary credentials to traverse a particular route (e.g. to open the doors/access the various rooms along the route). Such a credentials check may be performed by exchanging authentication data between the PIU 22b and control system 24 when a user requests a route. If the credentials check fails, the control system 24 may not send any route instructions and/or may alert an appropriate person of the request by the non-authorised user.

Additionally, or alternatively, the control system 24 can generate route instructions based on the mobility capabilities of a user. As an illustrative example of such functionality, the UGV1 may not be capable of traversing the stairs so the route for the UGV1 to light 2d comprises elevator access control 2i as the source location, with light 2d as the destination location.

As a further illustrative example, UAV1 may not be capable of navigating through Elevator1 or may not have the appropriate credentials to access Door1. Therefore, the control system will provide a different route to the light 2d, avoiding Door1 and Elevator1, whereby the route may comprise Fan1 as the source location, with Light1 as the destination location.

In the present illustrative example, the control system 24 can automatically request that Fan1 ceases functioning when UGV1 approaches the fan, while the control system 24 can instruct the Fan1 to resume operation when it's determined that the UAV1 has entered the third room 34. Such a determination may be made when the motion detector 2f is triggered by UAV1 or by monitoring the position of the PIU 22d.

Additionally, or alternatively, the control system 24 can generate route instructions based on the communication capabilities of a user. As an illustrative example of such functionality, the user's PIU may have limited communications capabilities (e.g. Bluetooth only) and may not be capable of interacting with Wi-Fi or ZigBee devices. As such, the control system can provide route instructions to a user to traverse between waypoints, even if the user's PIU cannot detect certain devices along the route. Such, route instructions may comprise instructions on how to open a door that would generally require interactions via Wi-Fi (e.g. by entering a code via an access keycode) and/or such route instructions may, rather than instructing the user to perform positional operations with a node device via ZigBee, provide a distance and direction bearing that the user's inertial reference unit can use to guide the user.

In embodiments, the node devices may be provided with one or more fiducial markers (e.g. a QR code or other suitable markers) which a user can use for identification and location purposes. As an example, the UAV may use the fiducial markers to correctly align with a node device or object (e.g. for mating with a light to remove and replace a lightbulb).

In embodiments, the control system 24 may generate routes dependent on facility attribute data. Such facility attribute data may comprise facility authorization data indicative of the required user authentication or authorization level required to access a particular area/zone or object in the facility (e.g. to open a door, call an elevator, enter a hazardous area etc.), and the control system will only include areas and objects in routes for users having the necessary user attribute data to pass through such areas and/or interact with such objects.

The facility attribute data may also comprise facility schedule data relating to locations or objects within the facility. As an illustrative example, the facility schedule data may indicate for example: when events are scheduled to take place, when smart objects are determined to be in operation. The control system 24 can then generate route instructions based on or in response to the facility attribute data.

As an illustrative example of the control system 24 generating routes based on or in response to facility attribute data, when the facility is a public space (e.g. a museum or library), the control system may avoid routes through exhibition space during public visiting hours as determined from the facility schedule data. Additionally, or alternatively, when the facility is a secure location such as a hospital, route instructions may only be provided to certain users having user attribute data meeting the authorization requirements defined in the facility authorization data (e.g. doctors or other authorised personnel).

As a further illustrate example, when the facility contains an area with machinery that is hazardous while in operation (e.g. an X-ray machine, particle accelerator, heavy machinery etc), any route instructions may avoid routes bringing a user in proximity to the machinery when scheduled to be in operation as determined from the facility schedule data. Additionally, or alternatively, route instructions may only be provided to certain users having user attribute data meeting the authorization requirements defined in the facility authorization data (e.g. scientists).

As a further illustrate example, when the facility, such as a zoo, contains a feeding pen for lions, the route instructions may avoid routes through the holding pen during scheduled feeding hours as determined from the facility schedule data. Additionally, or alternatively, route instructions may only be provided to certain users having user attribute data meeting the authorization requirements defined in the facility authorization data (e.g. a zookeeper or trainer).

As such, a person skilled in the art will recognize that although one route may be provided during certain times of the day, different routes may be provided at different times of the day based on or in response to the facility attribute data.

The facility attribute data may be manually updated by a user interacting with the control system.

Additionally, or alternatively, the facility attribute data may be generated by the control system 24 by performing data analysis on the data set to identify correlations therein. Over time, the control system can determine a schedule for a particular object or area, and update the facility attribute data for the object or area accordingly. The control system can then generate route instructions avoiding the object or area in response to the facility attribute data. The control system will further refine the facility attribute data over time in response to subsequent user behaviour. As an illustrative example, the area may be a feeding pen in a zoo, and the control system may initially generate route instructions through a lion feeding pen as it is determined to be the shortest route between two waypoints on the route. However, users provided with such route instructions will avoid the feeding pen while the lions are present, and the control system will, over time, identify correlations between the times the user passes through or avoids the feeding pen, and will generate facility attribute data accordingly, which can be used to enrich the data set from which improved route instructions can be generated.

As a further illustrative example, an object along a route may be an escalator with an upward direction of travel in the morning, and downward direction of travel in the afternoon. Users traversing a route in a first direction may traverse the part of the route having the escalator therealong during the mornings but avoid that part of the route during the afternoons. Similarly, users traversing the route in a second direction may avoid that part of the route during the mornings but traverse that part of the route during the afternoons. The control system will, over time, identify correlations between the times the user avoids/traverses that part of the route and will generate facility attribute data accordingly, which can be used to enrich the data set from which improved route instructions can be generated.

It will be appreciated that the control system is not required to understand the function of a particular object or area (for example, the direction of travel of an escalator, or about the danger of lions), but the control system can perform data analysis on the data set and generate the facility attribute data in response thereto as described above.

Furthermore, the control system can, in response to received data, generate graphs representative of the routes taken by the different users.

Any suitable graphs may be generated, and such graphs may comprise directed annotated graphs or tree graphs.

FIGS. 4a-4d are illustrative examples of directed annotated graphs 40a-40d generated in response to users traversing different routes; whereby root vertices (nodes) 42 represent a source location at which the user started the route, vertices 46 represent a destination location 46 at which the user ended the route, while vertices 44 represent one or more waypoints therebetween. The edges connecting two vertices are representative of a route between respective waypoints.

The vertices and edges may be annotated whereby the annotations associated with the respective vertices relate to the attributes of the corresponding node device or object (e.g. position, communication capabilities, access requirements, authorization levels, facility attribute data), and may also relate to facility attribute data (E.g. authorization level 4 required to open Door1; elevator operational between 9-2 pm). Similarly, the edge annotations relate to attributes of a route between respective waypoints (e.g. distance, direction, elevation, gradient etc.), and may also relate to facility attribute data (e.g. pathway not available between 12 pm-12 am; route is open to public Monday-Friday; route requires level 2 authorization; route requires safety helmet etc.).

It will be appreciated that the control system 24 may determine the vertices and edges for the directed annotated graph, and the respective annotations, based on, or in response to, the data received thereat in response to a user traversing a route (e.g. device attribute data; user attribute data, the operation data for the node devices and/or facility attribute data). The control system may also infer such vertices/edges by performing data analysis on the received data.

As an illustrative example of such functionality, and with reference to FIG. 4a, a user opens Door1 and the associated node device transmits operation data (e.g. via Bluetooth) to the control system to inform it that Door1 was opened by the user. The user's PIU harvests device attribute data from the associated node device (e.g. via Bluetooth) and transmits it to the control system.

In the present illustrative example, the control system can determine the distance and direction traveled by the user to Ladder1 based on the positional data received from the PIU, and can also infer the presence of Ladder1 in response to the user's elevation profile as the user climbs Ladder1.

When the user reaches Hatch1 at the top of Ladder1, a node device associated therewith transmits operation data (e.g. via Bluetooth) to the control system to inform it that Hatch1 was opened. The user's PIU harvests device attribute data from associated node device (e.g. via Bluetooth) and transmits it to the control system.

When the user subsequently reaches Door2, a node device associated therewith transmits operation data (e.g. via both Wi-Fi and ZigBee) to the control system to inform it that Door2 was opened. The user's PIU may inform the control system that it could not interact with Door2, but may provide other device attribute data (e.g. the user may manually input that it entered a keycode of “1111” to unlock the door)

In addition to transmitting its positional data to the system data, the user's PIU may emit a beacon so that the node devices can undertake position operations with the PIU, and transmit the position of the PIU to the control system. As such the user's position can be tracked as the user traverses the route. Such information may be used to enrich the data set.

As depicted in FIG. 4b, a user opens Door1 and node device associated therewith transmits operation data (e.g. via Wi-Fi) to the control system to inform it that Door1 was opened. The user's PIU harvests device attribute data from associated node device (e.g. via ZigBee) and transmits it to the control system.

In the present illustrative example, the user's PIU also comprises Bluetooth communication, and the PIU detects the signal strength of the Radio Beacon(Bluetooth) and transmits the measured signal strength to the control system. The Radio Beacon (Bluetooth) can also detect a signal from the PIU and inform the control system accordingly.

When the user reaches the Maintenance Door, a node device associated therewith transmits operation data (e.g. via Bluetooth) to the control system to inform it that the user opened the Maintenance Door. The user's PIU harvests device attribute data from associated node device (e.g. via Wi-Fi) and transmits it to the control system.

When the user subsequently reaches the Pump Controller, the user may, via the PIU, inform the control system 24 that the Pump Controller is being serviced, and request the control system to cut electrical power thereto, or to request the control system to divert water therefrom. The control system, in response, may transmit command data to a node device(s) associated with the Pump Controller to cut the power or to divert water therefrom. The user's PIU harvests device attribute data from associated node device (e.g. via ZigBee) and transmits it to the control system. The harvested data may also indicate that the Pump controller can communicate via Bluetooth.

As depicted in FIG. 4c, a different route is taken from the Pump Controller back to Door 1, whereby when the user reaches Hatch2, a node device associated therewith transmits operation data to the control system to inform it that Hatch2 was opened. The user's PIU harvests device attribute data from associated node device (e.g. via ZigBee) and transmits it to the control system.

The control system will infer the presence of Ladder2 in response to the user's elevation profile as the user descends Ladder2.

When the user reaches Elevator1, a node device associated therewith transmits operation data to the control system (e.g. via Bluetooth) to inform it that the user requested access to the ground floor. The user's PIU harvests device attribute data from associated node device (e.g. via ZigBee) and transmits it to the control system.

When the user reaches the Door1, a node device associated therewith transmits operation data to the control system to inform it that Door1 was opened. The user's PIU harvests device attribute data from associated node device (e.g. via ZigBee and Bluetooth) and transmits it to the control system.

As depicted in FIG. 4d, a user opens Door1 and node device associated therewith transmits operation data to the control system to inform it that Door1 was opened. The user's PIU comprises Wi-Fi communication and the user's PIU harvests device attribute data from associated node device (e.g. via Wi-Fi) and transmits it to the control system.

The user's PIU detects the signal strength of the Radio Beacon(Wi-Fi) and transmits the measured signal strength to the control system. The Radio Beacon (Wi-Fi) can also detect a signal from the PIU and inform the control system accordingly.

When the user reaches the Maintenance Door, a node device associated therewith transmits operation data (e.g. via Wi-Fi) to the control system to inform it that the user opened the Maintenance Door. The user's PIU harvests device attribute data from associated node device (e.g. via Bluetooth) and transmits it to the control system.

The Motion Detector may transmit operation data (e.g. via Wi-Fi) to the control system to inform the control system that motion was detected. The user's PIU harvests device attribute data from associated node device (e.g. via Wi-Fi) and transmits it to the control system, whereby the harvested data also indicates that the Motion Detector can communicate via ZigBee.

When the user subsequently reaches the Valve Controller and interacts therewith, the Valve Controller may inform (e.g. via Wi-Fi) the control system 24 that the user interacted therewith to request to undertake a service operation, and may also transmit any authentication data presented by the user to the control system for verification. The user's PIU harvests device attribute data from associated node device (e.g. via Bluetooth) and transmits it to the control system, and may further request to undertake a service operation therewith.

The control system, in response to the communications from the PIU and/or the Valve Controller (and checking the presented authentication data), may transmit command data to a node device(s) associated therewith to cut the power thereto.

As above, the users traversing the different routes depicted in FIGS. 4a-4d harvest device attribute data from all of the node devices with which they interact/detect along the route to further enrich the resulting graph. As different users traverse routes in the facility, the control system will receive further data to enrich the data set, whereby the vertices, edges and/or their respective annotations can be updated accordingly. The control system 24 will use the enriched data set to generate route instructions.

FIG. 5 is an illustrative example of an aggregated directed annotated graph representative of the data set harvested by the users depicted in FIGS. 4a-4d, and further depicts annotations associated with the respective vertices and edges. It will be appreciated that the annotations depicted in FIG. 5 (and in FIGS. 4a-4d) are illustrative only and more or fewer annotations may be provided.

The aggregated directed annotated graph of FIG. 5 is also representative of an enriched data set, in that it comprises routes 42 for a human user as determined from the data harvested by the users depicted in FIGS. 4a-4d, but also comprises routes 44 for a UGV, and routes 46 for a UAV, which may be identified or inferred using data analysis.

When a user requests a route to a destination location the control system can identify a suitable route from the aggregated directed annotated graph and provide a subset of the data set as route instructions to the user (e.g. a portion of the aggregated directed annotated graph).

As above, the route instructions may also be generated based on, or in response to the user's credentials and/or capabilities (e.g. communication or mobility capabilities), which may be provided as part of the request or may be stored at the control system.

Taking the illustrative example of FIG. 5, where the user is a human with a PIU having Bluetooth capabilities requesting access to Pump Controller, the control system can generate route instructions for a number of potential routes.

For example, the user, at or near Door1, may request a route to the Pump Controller avoiding ladders, whereby the control system could, from the data set, generate route instructions specifying Door1 as a source location, the Pump Controller as a destination location, with the Radio Beacon (Bluetooth) and Maintenance Door as waypoints to the Pump Controller.

In a further illustrative example, the control system may determine that the user is not authorised to open Maintenance Door, and will route the user using Ladder1, Hatch1, Ladder2 and Hatch2 as waypoints therebetween. As the PIU only has Bluetooth communications and Hatch2 has only ZigBee communications, the control system could generate a command to open Hatch2 as the user approaches (as determined from positional data received from one or more node devices and/or the user's PIU). In other examples, the control system could, as part of the route instructions, provide a keycode to the user to open the hatch via a keypad thereon (as determined from device attribute data previously harvested therefrom (e.g. by a commissioning device).

As a further illustrative example, when the user is a UGV, or a human with a ground vehicle (e.g. a cart), the control system will determine that the UGV cannot traverse ladders and route the user using the Radio Beacon(Wi-Fi), Radio Beacon(Bluetooth) and Maintenance Door as waypoints therebetween.

Similarly, when the user is a UAV, the control system will determine that there is an aerial route between Door1 and Hatch1, and a further aerial route between Hatch1 and Hatch2, and route the UAV therebetween accordingly.

As above, the size of the data set will be increased as different users traverse the map and as the number of node devices increases, thereby enriching the data set and the vertice/edge annotations such that the routes can be optimized and refined.

It will be appreciated that the source location may be any waypoint, and the user does not have to return to a particular root waypoint in order to receive route instructions. For example, for the illustrative example of FIG. 5, after servicing the Pump Controller, a user can be provided with directions to Door2, with, for example, the Pump Controller as the source location, and Door2 as the destination location, with the waypoints provided dependent on the user attribute data (e.g. the capabilities therein).

When a node device is relocated, the control system can automatically learn the updated position of the node device, whereby as users interact with the node device at its new location and transmit device attributes to the control system, the control system will, in turn, incorporate the new position of the node device into the routes.

It will be appreciated that the route instructions can be transmitted to a user via any suitable communications. Therefore, the PIU does not require GPS to navigate between the source location and destination location and the user can be directed to a destination location when GPS is not available (e.g. in subterranean tunnels).

However, the user may use GPS when it is available, whereby the route instructions can incorporate navigating between waypoints via GPS when the control system determines that the user will be capable of accessing GPS (e.g. if part of the route means the user is outside). Taking FIG. 5 as an illustrative example of such functionality, the user may be provided with directions from Door1 to Door2 via communications used in WLAN or WSN, while the PIU may use GPS signals from one or more satellites 48 to traverse from Door2 to Door3, and revert to communications used in WLAN or WSN when the user re-enters the facility at Door3.

In embodiments, the route instructions may be displayed to a human user as a directed annotated graph (e.g. showing only a portion of the directed annotated graph to which the route instructions relate), whereby the user can determine, from the annotations provided, when a particular waypoint is reached, and properties of that waypoint (e.g. what actions the user must take to communicate/interact with a node device, access codes for a keypad; communication capabilities, serviceable features of a particular device etc.).

Additionally, or alternatively, route instructions displayed to a user as a directed annotated graph may include the edge annotations, which may provide a user with attributes of the route between the waypoints, such as “Route between waypoint 1 and waypoint 2 requires climbing a stairs”, “Route between waypoint 2 and waypoint 3 requires authorization authorization level 2”, “Distance from waypoint 1 to waypoint 2 is 60 m”. The user could then determine whether it is capable of traversing the route, and, if not, requesting different route instructions avoiding a particular area or pathway. The user may also provide reasons for requesting a different route e.g. because the user is too tall or too heavy for the original route. It will be appreciated that the control system could then take such user input into account when generating routes for that user, or for different users having similar user attributes, in the future.

In other embodiments, the route instructions may be presented to the user as discrete text instructions, over SMS or push notifications for example, (e.g. describing each waypoint as the user traverses the route). Such text instructions may be provided in addition or as an alternative to the directed annotated graph.

In some embodiments, the control system will use node devices, smart objects or non-smart objects waypoints in routes, based on a confidence threshold of the accuracy/reliability of the device attribute data thereof. For example, while the control system may consider data received from an authorised user (e.g. a node device commissioner) to be reliable, the control system may consider data received from node devices themselves (e.g. in response to an event) or from a non-authorised user (e.g. a maintenance engineer) as being unreliable, and may not use the node device or associated smart object as a waypoint until the reliability/accuracy of its device attribute data is considered to be above a specified confidence threshold.

As an illustrative example, a plurality of different users may measure substantially similar signal strengths from a radio beacon as the different users traverse along a particular path. The control system can take the reliability of the measured signal strength to be above the confidence threshold when a number (n) of users traversing the same route measure substantially the same signal strength from a radio beacon (e.g. n>5).

In further illustrative example, an access control device will detect when a number of users open a door, while a motion detector will detect the door opening or detect users as they pass through the door. The control system will identify a correlation between opening the door and the motion detector being triggered, and when the correlation occurs ‘n’ times, the control system will incorporate the motion detector and/or door as waypoints in future routes.

Furthermore, it will be appreciated that although a particular user may not have the capability to interact with all of the node devices along a route, the particular user may, nonetheless, be provided with instructions for traversing the waypoints by the control system.

For example, rather than providing instructions to detect a Bluetooth signal from a node device, the control system can provide appropriate route instructions to a user having only Wi-Fi capabilities (e.g. “Continue 10 m North to light2”). Similarly, rather than providing the same user with instructions to interact with an access control device on a Door via ZigBee, the control system can provide instructions such as “Use Keycode 0000 to open Hatch2.” Such functionality means that users need not all have PIUs with the same capabilities.

Such functionality also means that the route instructions generated by the control system are more likely than not to result in a user successfully traversing from a source location to a destination location even when he does not have the capability to interact with all node devices along the route.

Furthermore, the control system may infer a potential attribute for a node device or object or a potential attribute for a route between two waypoints, and annotate the respective vertices/edges with the inferred attributes, such that the control system will generate route instructions in response thereto until the inferred attribute is determined to be incorrect. As an illustrative example, the control system may identify from the data set that UGVs do not traverse between two particular waypoints, and thus infer that the edge is unsuitable for UGVs, and annotate the edge with the inferred attribute accordingly (e.g. “not suitable for UGVs”). The control system may update the annotations/future route instructions if a UGV is subsequently detected traversing between the particular waypoints.

While FIG. 5 discloses using a directed annotated graph from which to generate route instructions, the claims are not limited in this respect and the control system may generate route instructions from non-directed graphs (e.g. graph trees) or non-graph related methods.

A directed annotated graph provides advantages over other types of graphs such as tree graphs. For example, as depicted in FIG. 5, the directed annotated graph comprises annotations associated with the respective vertices and edges, whereby the respective annotations may be used as decision points by the control system when generating route instructions for the different users.

As an illustrative example, on determining the presence of ladders from the vertices/edges annotations, the control system will avoid including the ladders in route instructions for users that cannot climb ladders (e.g. UGVs). As a further illustrative example, on identifying walkways having width, height and/or weight restrictions from the vertices/edges annotations, the control system will avoid including the walkways for users exceeding the restrictions in the route instructions. As a further illustrative example, on identifying areas in the facility subject to time restrictions (e.g. closed on a Saturday to non-authorised users) or areas in the facility subject to certain authorization requirements (e.g. only access provided to Users having level 4 clearance), the control system will avoid including such areas in the route instructions dependent on the user's authentication data. As a further illustrative example, on identifying vertices/edges requiring certain user capabilities from the vertices/edges annotations (e.g. edge requires 7Wh to traverse with autonomous vehicle model Z; edge requires ascending a ladder; edge requires traversal of 15 m of high resistance floor (e.g. grass)), the control system will avoid including such areas in the route instructions dependent on the user's capabilities data.

Furthermore, the directed annotated graphs allow for the most suitable source waypoint for a particular route to be determined. As an illustrative example of such functionality, when a user drives to a facility, but then needs to traverse a route inside the facility, the control system will select the most appropriate source waypoint inside or outside the facility as the source waypoint.

As a further example, and as illustratively shown in FIG. 5 and described above, directed annotated graphs provide multiple routes to a particular destination location (e.g. dependent on user attribute data, facility attribute data etc.).

Furthermore, the directed annotated graphs provide directedness, whereby a route between waypoints in a first direction e.g. from a first waypoint to a second waypoint may have different properties in comparison to a route between the waypoints in a second direction e.g. from the second waypoint to the first waypoint, which can be determined from the directed annotated graph.

As illustratively depicted in FIG. 5, access Hatch1 requires a keycode when a user traverses waypoints in the direction D1, but does not require any authorization when the user traverses waypoints in the direction D2. Similarly, Door2 requires a first keycode when a user traverses waypoints in the direction D1, and requires a different keycode when a user traverses waypoints in the direction D2. As a further illustrative example, ramps may require more energy to traverse in one direction than the other (e.g. up vs down); while a route may include an escalator in a first direction and a stairs or ladder for a second direction. Such directedness may mean that a user may be capable of traversing a route in a first direction, but not in a second direction as will be identified by the control system based on or in response to the user attribute data, and taken into account when generating route instructions.

FIG. 6 is a simplified flow diagram illustrating a method 100 of creating a data set at a control system from which route instructions can be generated.

At step S100, the method 100 starts.

At Step S102, a user, via an associated PIU, interacts with node devices in a facility to harvest device attribute data therefrom. Such device attribute data may relate to one or more attributes of the node devices such as: device type; device control capabilities; sensing capabilities; device identifiers; communication capabilities. The device attribute data may also comprise location attributes of the node devices.

At Step S104, the node devices transmit operation data to the control system, whereby the operation data relates to the operational state of the node device or an associated smart object. The operation data may be transmitted from the respective node devices to the control system at some interval (e.g. every hour, day etc), or based on some triggering event such as, for example: a physical event, an acoustic event; an optical event; a radio event.

At Step S106, the user's position may be tracked e.g. by positional data received from the user's PIU and/or from the node devices.

The control system stores the received data (e.g. device attribute data, user attribute data and/or operation data) as a data set and at Step 108, the control system determines the positions of the node device/associated smart object in the facility, and the device attributes thereof. The control system also determines the position and attributes of one or more non-smart objects in a facility, based on, or in response to, analyzing the data set. Such an analysis may be performed using an artificial neural network. In other examples, a user may manually input the position/type of such non-smart object(s).

The control system may generate a directed annotated graph representative of the route taken by the user.

Steps S102, S104 and S106 are repeated for different users, whereby the data set may be enriched as the different users interact with one or more node devices in the facility, whereby the enriched data set is analyzed to optimise/refine the routes.

At Step 110, the method Ends.

FIG. 7 is a simplified flow diagram illustrating a method 200 of generating, at a control system, a route from a source location to a destination location.

At step S200, the method Starts.

At Step S202, a user requests, via a PIU, access to a destination location, which may for example comprise a node device, an associated smart object or a non-smart object.

At Step S204, the control system processes the request to verify the user attribute data to generate an appropriate route for the user, whereby, dependent on the user's credentials and/or capabilities.

At Step S206, the control system analyzes the data set, and at Step S208 generates a suitable route for the user comprising a source location, a destination location and one or more waypoints therebetween.

At Step 210, the control system transmits the route instructions to a user's PIU to enable the user to reach the destination location. The route instructions may be presented as human readable instructions for a human user (e.g. as a map, in the form of a directed annotated graph or other suitable map, and/or as text instructions), whereby the route instructions may include actions the user must perform to traverse the respective waypoints (e.g. “use push button to call lift”; “use code ‘XXXX’ to unlock door”; “use handle to open door”; “walk 10 m South”; “climb ladder” etc;). In other examples, the route instructions may comprise command data for an automated user.

At Step S212, the control system monitors the user's progress along the route by analyzing the operation data and/or the positional data from the PIU as the user traverses the route.

In examples, route instructions can be transmitted to the user for waypoints along the route once the previous waypoint has been successfully reached. As an illustrative example of such functionality, the route instructions from a first waypoint to a second waypoint may be transmitted to the user as/when it approaches the first waypoint, while the route instructions from the second waypoint to a third waypoint may be transmitted to the user as/when it approaches the second waypoint. Such functionality may increase the likelihood of the user successfully reaching a next waypoint.

At Step S214, the user reaches the destination location and the method ends.

The present techniques provide a control system which generates route instructions based on or in response to data harvested from node devices, to enable a user to traverse from a source location to a destination location via waypoints in a facility.

Providing the user with instructions to traverse between waypoints means that the user can efficiently navigate the route in a manner that can be tracked by the control system.

Furthermore, the control system can provide routes based on a user's attributes (e.g. credentials/capabilities), whereby when the control system determines that the user is not authorised to access areas along a certain route, the control system can provide a different route through areas for the user does have authorization. The control system can, using such functionality provide users with access to restricted areas without issuing the users with individual access cards, and whereby the control system can monitor the positions of users along a route, and unlock/lock doors to authorised areas as appropriate.

Similarly, the control system can determine when a user is not capable of traversing one or more routes to a destination location (e.g. because of the presence of stairs or a door etc.), and provides route instructions for a route which the user is capable of traversing.

Furthermore, the control system can analyze the data set to identify patterns in the user's routes/or access requests to node devices or objects and provide route instructions based on the analysis. As an illustrative example, the control system may identify that engineers request access to service a particular object every 12 months. The control system can then, in response to the analysis, determine whether access should be granted based on whether a request is received within an expected time period. For example, if an engineer requests access to service the particular object at six following a service, the control system may not send route instructions or may request authorization from a further party to generate route instructions (e.g. an owner of the facility).

In other examples, the control system can schedule proactive maintenance based on the analysis, whereby, for example, the control system may identify that a particular node device is accessed every 10months (e.g. replacing fluid in the air conditioning unit), and organize an engineer or an automated/computerised vehicles to service the node device at 9 months.

The control system may generate the route instructions in response to facility attribute data, whereby maintenance may be scheduled during periods when a fast route and/or a safe route can be provided to a user.

As an illustrative example, an elevator may be available in a facility during certain times of the day. The control system may communicate with an engineer (e.g. via SMS) to schedule maintenance to take place during the period that the elevator is available, and generate route instructions which include the user taking the elevator. Such a route may be faster and safer for the user in comparison to climbing a ladder.

As a further illustrative example, lions may be fed in a feeding pen in a facility such as a zoo during certain times of the day. The control system may schedule maintenance within the facility to take place during the period that the lions are not in the feeding pen as determined from the facility attribute data, and generate route instructions which include the user passing through the feeding pen which may be a faster route for the user in comparison to traversing a route avoiding the feeding pen.

Furthermore, the present techniques also enable a maintenance contractor to determine how difficult it will be to access one or more devices or objects in the facility, and to establish service level agreements with the facility's management/owners based on the determined difficulty.

Furthermore still, while the illustrative examples above generally describe navigation in land-based facilities, the techniques are equally applicable to sea-based facilities such as an ocean-going vessels. Such techniques may be beneficial over existing technologies used to provide navigation within such vessels. For example, GPS navigation may be complicated by the movement of these vessels and/or the metal materials generally used to construct such vessels. Similarly, inertial navigation would require an inertial reference signal with respect to the vessel and this signal may also be blocked by the metal materials.

Embodiments of the present techniques further provide a non-transitory data carrier carrying code which, when implemented on a processor, causes the processor to carry out the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

In the preceding description, various embodiments of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method of generating route instructions for a user, the method comprising:
receiving, at a control system, device attribute data for a plurality of node devices in a facility;
storing, in a data set, the device attribute data, wherein the data set further comprises operation data relating to the operating state of respective node devices;
receiving, at the control system, user attribute data for a user;
generating, at the control system, route instructions specifying a source location, a destination location and one or more waypoints therebetween based on or in response to the data set and the user attribute data;
transmitting, from the control system to the user, the route instructions.

2. The method according to claim 1, wherein the one or more waypoints comprise:
the plurality of node devices, objects associated with the plurality of node devices and, one or more non-smart objects.

3. The method according to claim 1, the method further comprising:
receiving, at the control system, updated device attribute data for the plurality of node devices;
updating the data set in response to the updated device attribute data.

4. The method according to claim 1, wherein the data set further comprises facility attribute data, and wherein the route instructions are generated based in or in response to the facility attribute data.

5. The method according to claim 4, wherein the facility attribute data comprises one or more of: facility schedule data and facility authorization data,

6. The method according to claim 1, further comprising:
performing data analysis on the data set; and
generating the route instructions based on or in response to the data analysis.

7. The method according to claim 1, wherein the user attribute data comprises one or more of: user type data, user capabilities data, user authentication data and user positional data.

8. The method according to claim 7, the method comprising:
verifying, at the control system, the user's capabilities data and/or authentication data;
generating the route instructions based on the verification.

9. Th method according to claim 1, the method further comprising:
guiding the user along the route defined in the route instructions.

10. The method according to claim 9, wherein guiding the user comprises:
transmitting command data to a node device to perform an action.

11. The method according to claim 9, further comprising:
transmitting, to the user updated route instructions in response to determining that the user has deviated from the specified route; and/or
signaling to the user or another party that user deviated from the specified route.

12. The method according to claim 1, wherein the route instructions define actions for a user to perform to traverse between the waypoints, wherein the actions are defined in response to the user attribute data.

13. The method according to claim 1, wherein the waypoints specified in the route instructions are above a specified confidence threshold for the device attribute data.

14. The method according to claim 1, and further comprising:
generating, a directed annotated graph representative o f the data set, wherein each of the vertices of the directed annotated graph is representative of a waypoint.

15. The method according to claim 14, wherein an edge connecting vertices of the directed annotated graph represents one or more of: a route between the connected vertices.

16. The method according to claim 14, wherein the route instructions comprise a portion of the directed annotated graph comprising the specified waypoints.

17. The method according to claim 15, further comprising:
annotating one or more vertices or edges with attributes based on or in response to the data analysis;
generating the route instructions based on or in response to the annotations.

18. The method according to claim 17, further comprising:
inferring a potential attribute for one or more vertices and/or for one or more edges;
annotating the respective vertices or edges with the inferred potential attribute;
generating the route instructions based on or in response to the inferred attribute.

19-20. (canceled)

21. A method of generating, route instructions in a facility, the method comprising:
harvesting, at a first data processing unit, device attribute data from one or more node devices in the facility;
transmitting, from the first data processing unit to a control system, the device attribute data;
generating, at the control system, route instructions for a user, the route instructions specifying a source location, a destination location and one or more waypoints therebetween based on or in response to the device attribute data and the use attribute data;
transmitting, from the control system to a second data processing device, the route instructions.

22-24. (canceled)

25. A non-transitory data carrier carrying code which, when implemented on a processor, causes the processor to carry out the method of claims 1.

26-27. (canceled)
